(19) United States
(12) Patent Application Publication
(10) Pub. No.: US 2023/0302462 A1
(43) Pub. Date: Sep. 28, 2023

(54) AQUEOUS COMPOSITION WHICH IMPROVES THE EFFICIENCY OF HYDROMETALLURGICAL AND PYROMETALLURGICAL PROCESSES FOR METALS WHEN USED IN SAME, SAID COMPOSITION COMPRISING: AN AQUEOUS BASE, ONE OR MORE SURFACTANTS, ONE OR MORE ADJUVANT GASES IN THE AFOREMENTIONED PROCESSES, ADDED THERETO AS NANO- AND MICRO-SIZED BUBBLES

(71) Applicants: Eugenio Ovidio LIZAMA MORENO, Santiago (CL); Rene Eduardo DAHMEN LEMUS, Antofagasta (CL)

(72) Inventors: Eugenio Ovidio LIZAMA MORENO, Santiago (CL); Rene Eduardo DAHMEN LEMUS, Antofagasta (CL)

(21) Appl. No.: 18/000,489

(22) PCT Filed: May 28, 2021
(86) PCT No.: PCT/CL2021/050050

§ 371 Date: Dec. 16, 2022

Related U.S. Application Data
Application No. PCT/CL2021/050050 is a continuation of application No. 17/066,247, filed on Oct. 8, 2020, now abandoned.

(30) Foreign Application Priority Data
Jun. 1, 2020 (CL) 1458-2020

(51) Int. Cl. B03D 1/008

(52) U.S. Cl. CPC B03D 1/008; B03D 2201/04; C22B 3/16

(57) ABSTRACT

One or more surfactants and one or more adjuvant gases in the hydrometallurgical and pyrometallurgical processes, which are added thereto in the state of nanobubbles and microbubbles, both the gases used and the nanobubbles and the microbubbles thereof, are in a variable proportion depending on the physicochemical requirements of each of the stages of the process where it is applied. The nanobubbles and microbubbles, of the proposed composition, make it possible to significantly increase the physicochemical properties of these gases such as: flotation speed, oxidizing power, reducing power, contact area provided and coalescence speed.

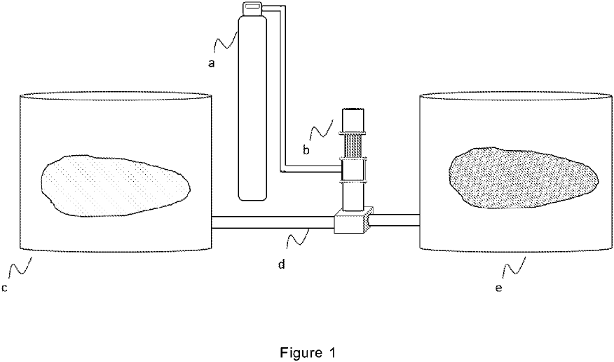

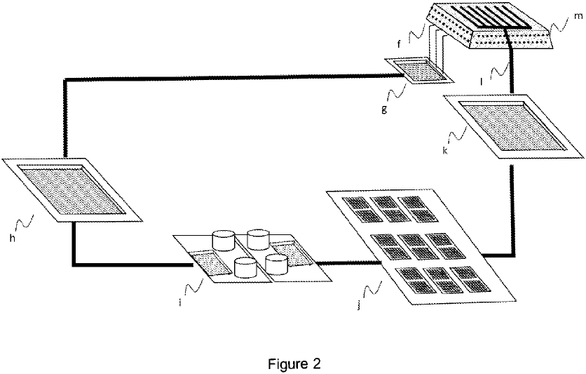

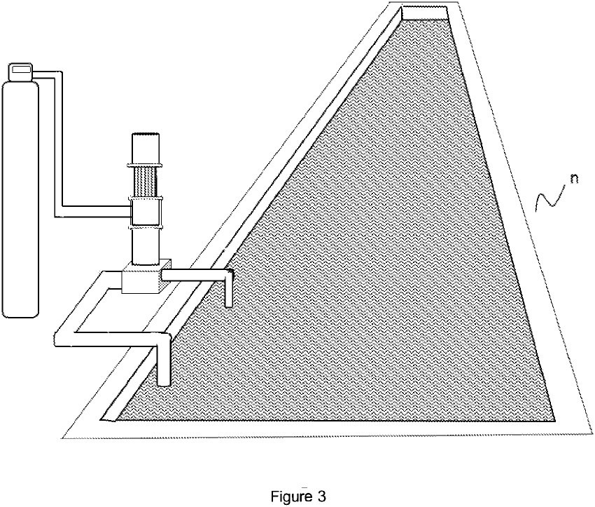

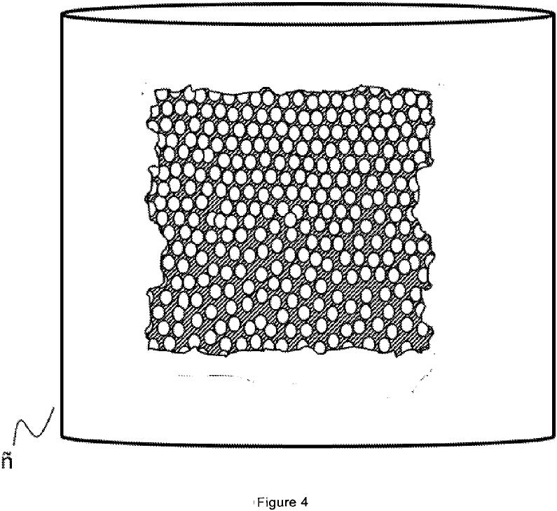

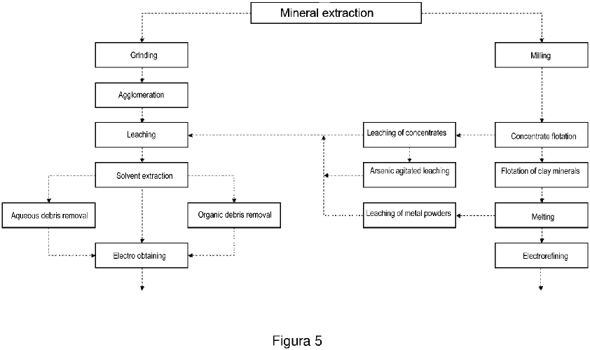

The present application claims the priority of Chilean Patent Application 202001458, filed Jun. 1, 2020, the contents of which are incorporated by reference in their entirety. In addition, the present application claims priority to U.S. Pat. Application 17/066,247, filed on Oct. 8, 2020, the contents of which are hereby incorporated by reference in their entirety.

The present application proposes an aqueous composition that, through its application in strategic stages of the hydrometallurgy and pyrometallurgy processes of metals, increases its efficiency, comprising: An aqueous base, one or more surfactants, one or more adjuvant gases of the aforementioned processes, added thereto in size of nanobubbles and microbubbles, their method of obtaining and method of application.

### DESCRIPTION

The present application promotes an aqueous composition that is applied in strategic processes and that has a greater impact on the efficiency of hydrometallurgy and pyrometallurgy, such as: agglomeration, mineral leaching, solvent extraction, flotation, electrorefining and that, by applying them, increases their efficiency.

The aqueous composition of the present application comprises: One or more surfactants and one or more adjuvant gases in the hydrometallurgical and pyrometallurgical processes in which it is applied, which are added thereto in the state of nanobubbles and microbubbles. In addition, it understands that both the gases used and the nanobubbles and the microbubbles thereof, are in a variable proportion depending on the physicochemical requirements of each of the stages of the process where it is applied.

### PRIOR ART

Within the techniques used for the extraction of valuable metals, from the minerals that contain them such as: Copper, Zinc, Silver, Lead, Gold, Uranium, etc., are the processes of pyroetallurgy and hydrometallurgy. The use of one or another system depends on the mineralogical characteristics of each mineral.

Pyrometallurgy is used for the processing of sulphurized or minerals that require the release of the species by means of a milling, highlighting the following stages:
Extraction
Grinding
Milling
Flotation
Thickening
Melting
Electrorefining.

After the extraction, grinding and milling processes, the sulfur mineral is in a position to be treated in the next flotation step. This consists of contacting the mineral finely divided by the successive stages of grinding, dry milling, wet milling and classification, with an aqueous solution to which a series of chemical reagents are incorporated.

In the mixture of mineral and water, an air flow is injected, which generates a multitude of bubbles that rise towards the surface of the solution, which results in the particles of valuable mineral adhering to the surface of the bubbles, being dragged by them and collected on the surface of the solution for subsequent drying and melting. The purpose of this process is to obtain from the ground mineral an intermediate product called “Concentrate”, which contains a concentration of valuable mineral between 20 to 60%, according to the species present in the process.

The flotation process encompasses the following steps:

1. The mineral is wet ground to an average of approximately 48 mesh (297 microns), depending on the type of mineral.

2. The pulp that is formed is diluted with water and its pH adjusted to reach a percentage of solids by weight between 25% and 45%.

3. Small amounts of reagents are added, which modify the surface of certain minerals.

4. Another reagent, specifically selected, is added to act on the mineral to be buoyantly separated. This reagent covers the surface of the mineral making it aerophilic and hydrophobic, called a collector.

5. Then another reagent is added, which helps establish a stable foam, which is called a foaming agent.

6. The chemically treated pulp in an appropriate deposit comes into contact with air introduced by agitation or by direct addition of air at low pressure.

7. The aerophilic mineral, as part of the foam, rises to the surface, from where it is extracted. The depleted pulp passes through a series of tanks and cells, in order to provide time and opportunity to the mineral particles to contact air bubbles and can be recovered in the foam.

The particle size of the mineral is a relevant parameter in the flotation process. In the literature (Gaudin, et al., 1931; Morris, 1952) various works can be found that report the effect of particle size on the recovery of the valuable mineral. Wyslouzil et al. (2009) indicate that the efficiency of the flotation process is negatively impacted when operating at the extremes.

For example, in the flotation of phosphate minerals in conventional cells the optimal particle range is usually in fractions between 45 µm and 150 µm. In the case of copper, mentioned by Jameson (2013), who indicates that the recovery of particles greater than 150 µm is deficient when conventional cells are used, despite the fact that said particles could be adequately released to be floated. In accordance with best practices of the industry, it is concluded that the optimal result is floated with particles of an average size of 38 µm to 100 µm, in order to optimize the recovery of the valuable mineral.

In accordance with the foregoing, a major challenge in the flotation step is related to difficult treatment of fine and ultrafine particles (< 38 µm), which, not coming into contact with the surface of the bubbles is not transported, generating a huge loss of recovery of this fraction of size.

Data obtained from the industry establishes losses can be between 20 to 80% of the treated mineral, under this fraction of size, which is very important for this industry, considering the high mass flows that are treated in this type of concentrator plant. For example, Minera Centinela has a processing of 100,000 tons/day of mineral.

Along with the foregoing, there is the phenomenon that when high specific gravity minerals are processed, for example galena, free gold, cassiterite, etc., and in fragile minerals such as Molybdenite, a phenomenon called “Lameo” is generated when it is processed with a fine milling, which it is not possible to recover by conventional methods. Field experiences have been able to demonstrate that smaller bubbles favor the coalescence of the particles with the bubble, generating a favorable impact on the kinetics and recovery of the valuable metal.

In the flotation of copper sulphides from porphyry copper mineral such as: chalcopyrite, chalcocyte, enargite and coveline, there is often a problem of low flotation efficiency that is generated by the high content of fine clay.

The presence of this fine clay results in a silt coating on the mineral particles even when fresh water is used. Clay minerals, such as kaolinite and illite, are ores in these mines.

In copper sulphide floats, regardless of the type of copper sulphide associations or the type of clay mineral present, the latter will always be present because they are easily released during the milling process.

The problem represented by the presence of clays is in the thickening step, where the separation of the clays is difficult, this is mainly due to its small particle size and its electrical charge. As a result of the above, the waters used accumulate a large amount of fines and clays in suspension that could not be flocculated or separated respectively

In addition, fine clay particles make it difficult to float copper mineral, due to the coating they generate on the surface of valuable minerals.

The displacement of gangue slits towards concentrates may also present significant problems of dilution of concentrates, as well as require much higher flotation residence times to ensure a high recovery of the copper mineral. In a plant where the flotation capacity is fixed, this means lower copper recoveries.

Owing to the ageing of sulphurized mineral reservoirs, increasingly complex minerals must be treated, which have polluting elements that make their processing difficult and high cost, which complicates their commercialization. One of these elements is arsenic. This element is very complicated to process by pyrometallurgical methods, due to its impact on the environment when treated in the melting.

Therefore, the sulphurized minerals containing a higher arsenic content are treated by a special process called agitated leaching. In this process the leaching solution is agitated vigorously and heated to 60° C. Then, an excess of hydrogen peroxide is added to precipitate the arsenic (III), to arsenic (V). This procedure is called arsenic abatement, since it does not eliminate it, but minimizes its impact in the subsequent stages.

The use of hydrogen peroxide in this process entails a huge risk of accidents, because it is very difficult to handle and its storage and transport entails a huge risk of personal accidents and environmental pollution.

A series of studies and developments have been carried out to be able to leach copper concentrates and thus avoid the process of melting concentrate. For this purpose, it is sought that the components, which are mainly sulphurized, react with a leaching aqueous solution and thus be able to obtain the metal in an electro-obtaining process

Hiroyoshi, in the year 2000, postulated a two-step reaction model for the dissolution of chalcopyrite promoted by iron, first chalcopyrite is reduced by ferrous ions in the presence of cupric ions to form chalcosine, then chalcosine is oxidized (more easily than chalcopyrite) by dissolved oxygen or ferric ions to form cupric ions and an insoluble elemental sulfur product.

What in turn can be seen in practice in the leaching of other primary copper sulphides such as the bornite that first pass through a relatively high kinetic solution forming idalite, which rust again, this time with the slower speed (similar to coveline) to form chalcopyrite and elemental sulphur, as represented below.

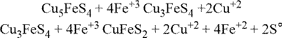

In 2005, G Fuentes, in the journal of metallurgy, Madrid 41 (384-392), refers to the leaching of copper concentrates by means of copper chlorine-complexes, generated in situ by the reaction between the Cu (II) from the soluble copper of the concentrate and sodium chloride in acidic medium. The experimental results indicate that it is possible to obtain solutions with copper contents between 15 and 35 g/l and 2 to 5 g/l of free acidity, with suitable characteristics to enter the solvent extraction step. The procedure uses, alone, common and very low-cost reagents, such as NaCl and dilute sulfuric acid. The advantage of this procedure is to recover, at very low cost, all of the soluble copper and between 10 and 15% of the sulphide copper.

Subsequently, experiments with Ozone were carried out by Carrillo-Pedroza et al (2010) in chalcopyrite, where they studied the use of this element in a sulfuric/ferric acid system, for which agitated isothermal tests were performed at 25° C., on a 0.7% law mineral sample, which was divided into small size fractions and leached with a solution of 0.1-0.5 M H2SO4 and 0-0.5 M Fe⁺³. The results showed a reduction in leaching times and a 16% increase in extraction, noting that there was no consumption of d =3 by the gangue and that leaching was less effective in size fraction. In this system, the mechanism is represented with the following reaction.

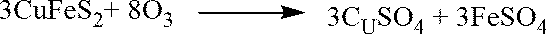

In the journal Remetallica, 2017, Vol. 33 / No. 21 / Pag 41-49, refers to a study called “Evaluation of the use of hydrogen peroxide and cationic surfactant ctab ((Hexadecyltrimethylammonium bromide CAS 57 09 0) in the leaching of a copper concentrate in acid medium”, reaching good results with chalcopyritic copper concentrate. There is a direct relationship between the amount of hydrogen peroxide added and recovery, reaching a value of 44% with 2.8 M peroxide and 2.5 M sulfuric acid and fine size of concentrate. This value is raised by adding a surfactant at a concentration of 4.108 mM CTAB, reaching a value of 65% recovery.

Currently in Chile, a project called “Leaching of concentrates” is being developed, (Exempt Resolution N° 0276/2017), which consists of the Construction and operation of a Concentrate Leaching Plant (PLC) in an autoclave, with a capacity of 220 ktpa, at 28 bar of pressure and 220° C. of temperature, whose objective will be to process copper concentrates with arsenic content and test powders, whose process produces a recovery of copper, generating a copper-rich PLS and an arsenic residue.

The normal operation of the autoclave considers the feeding of pulp continuously to the first compartment from the storage and feeding tank, via high-pressure pumps at a flow of 45 tons/h. To promote the dissolution reactions of the concentrate inside the autoclave, high purity oxygen (99.5%) is injected at an overpressure of 500 kPa (72 PSI) in a controlled manner in each of the compartments (estimated consumption of 174,210 tons of oxygen are required for this process annually).

The residence time of the autoclave is between 45 and 60 min. The foregoing, according to its statement, indicates that the autoclave leaching process reaches a copper recovery > 98.7% and an arsenic abatement ≥ 85%.

The chemical reactions inside the autoclave are exothermic generating a large amount of heat, making it necessary to constantly inject cooling water into the different compartments to maintain and control the temperature at 220° C.

The copper concentrate obtained from the flotation step is melted in high temperature furnaces, where a purity metal of about 99.5% is obtained. Product of this process, impurities and valuable metal are eliminated in the process, which are captured by the particle collection systems containing the melts, collecting the particles containing the valuable metal and also contaminants such as: copper, silver, arsenic, bismuth, nickel, etc.

These are captured by filtration devices and traps that capture these elements for subsequent use, from which a product called “melting powders” is obtained. In the case of copper, for example, they are mainly subjected to a special agitated leaching process, where the copper is released and a PLS (pregnant leaching solution) is obtained.

In this process, the casting powders are contacted with an acidic aqueous solution or electrolyte with temperature and hydrogen peroxide is added, in order to leach the metallic powders, which hinders and significantly raises the price of the process, this because hydrogen peroxide is difficult to handle and carries a huge risk of personal accidents.

The final process of the Pyrometallurgy corresponds to the electrorefining, which uses the electrolysis as a means to achieve the purification of the metal obtained from the melting. The metal to be refined is arranged in the form of anodic plates, in cells or vats containing an electrolyte containing preferably sulfuric acid and copper sulfate in the case of copper and in addition to cathodes, motherboards or initial sheets are used, which product of the passage of the current, from an electrical source, the metal is deposited in the cathode, leaving the impurities contained in the anode sludges that are formed in the bottom of the cells.

Electrorefining is a process very similar to electroplating, which uses the principles of electrolysis to deposit one metal on another. In the early days of electroplating, deposit-regulating additives such as thiourea, guar gum, fish tail and other chemical agents were used. Because in electroplating the completion requirements and properties of the deposit are very demanding, different deposit regulatory agents such as those derived from benzyl sultanic and benzoic acid were developed. This has allowed the development of this technique. Currently, qualities such as surface brightness, internal tension, hardness, and homogeneity of the deposits can be controlled.

In electroplating processes, the process of glossy copper plating or acid copper plating is widely used, where an electrolyte is used that contains 220 grams per liter of copper sulfate and 33 cubic centimeters per liter of sulfuric acid. To regulate the qualities of the deposit, different additives are added such as those already mentioned, which act as grain refiners or brighteners, thereby obtaining a smooth, homogeneous and shiny deposit. This process is very similar to that of electro-obtaining and electrorefining, since they comprise the same elements and operating conditions.

Until the late eighties, to solve the problems of passivation of the anodes mainly nickel-plated and in the glossy copper plating, a series of perforated pipes were arranged at the bottom of the tanks and under the anodes through which air was injected into the system. In practice this solved the problem of passivation, by agitating the solution and providing a greater amount of dissolved oxygen, generating the detachment of the anode sludge that covers the passivated anode. On the other hand, the formation of these sludges also decreased and the copper baths that used air for agitation remained a greater number of days without requiring filtration of anodic wastes. In spite of the foregoing, this technique of air agitation was stopped due mainly to two drawbacks that it presents: The air that was injected with a blower at room temperature, generated a cooling of the electrolyte, in addition to adding impurities present in the atmospheric air, which accumulated in the electrolyte, contaminating it.

Along with the above, the acid bunching baths are very difficult to operate, because the phenomenon of anodic passivation occurs, so the work cycles must be short, after one to two hours of copper plating it must be allowed to rest, so that the passivation layer of the anode is detached from the anode and decanted, after which the work can be restarted.

Electrolytic refining presents the challenge of anodic passivation, due to the contaminations that are present in the anodes, for example, copper anodes, where these are mainly passivated by the oxygen content contained therein at the time of molding and other metals, which, when present, generate as cuprous oxide, encourages passivation and the formation of anode sludge. Cuprous oxide takes longer to react with electrolyte.

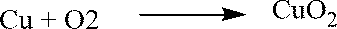

This implies high energy consumption, which causes a low current efficiency in the electrorefining bays and an increase in the formation of anode sludge, which causes an increase in the frequency of cleaning of the cells or cold filtration. To carry out this process, it is necessary to stop the work of the cells for fog days and remove the anode sludge from the bottom of each cell, along with involving serious risks of personal accidents.

The process of hydrometallurgy is used for the processing of minerals mainly oxides, mixed and sulphides and its main processing stages are:

Extraction, grinding, agglomeration, leaching, solvent extraction and electro-obtaining

After extraction and grinding, it is subjected to the agglomeration process that aims to prepare the mineralized material for the leaching process, thus guaranteeing a good coefficient of permeability of the leaching solution. This process is carried out by means of an equipment called “Agglomerating Drum”, which consists of a tubular-shaped equipment that rotates on its axis and inside which the mineral, water and sulfuric acid are mixed. In this way, the ground mineral is brought together, forming a spherical structure called “Glomer”, composed of coarse and fine particles joined together.

Subsequently, in the leaching step, the agglomerated mineral is transported and accumulated in areas called “piles”, where the mineral is contacted with an aqueous solution called leaching solution, which contains an acid that reacts with the mineral, in this way the valuable metal forms ions with the acid and enriches the solution, which is subsequently subjected to the electrodeposition process or another process to obtain the valuable metal.

There are different types of leaching for the different minerals, which are grouped in:
a. Leaching in situ: It is applied directly to the mineral at the site of the deposit without subjecting it to any mining extraction work.
b. Leaching in dumps: This consists of processing low-grade minerals, this is mainly primary and secondary sulphides with sub-marginal laws, without subjecting them to a reduction in size and in places available for large stockpiles.
c. Leaching Flooded trays: It corresponds to a technique used mainly for oxidized minerals that present a rapid release of copper, when they are subjected to a flooding process and flow in countercurrent.
d. Leaching by agitation: It is used for minerals that cannot be leached by traditional methods, due to its characteristics, performing this operation continuously or batch, by means of an agitation of the mineral.
e. Leaching with Pressure: It is a technique that by means of the modification of the pressure allows to reach elevated temperatures, in batch systems called autoclaves, which allow to modify the speed of the reaction.
f. Leaching in piles: This corresponds to the most commonly used conventional technique, where the mineral is ground to a target size, then agglomerate and begin with a wetting and irrigation process. This is mainly used for oxidized minerals, but it is also used for primary sulphides, which may be present, where chemical leaching or with the help of microorganisms are used, depending on the definition of the mining company.

In the different types of leaching, the addition of air is essential to these processes, where there is a need to maintain a uniform oxygen distribution, due to the existence of bacterial leaching and/or acid leaching, which can be considered as a biochemical oxidation process that is catalyzed by the presence or absence of microorganisms in the ferrous ion, which is represented as follows.

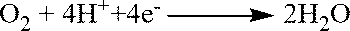

The oxidation of the ferrous ion is possible mainly by the molecular oxygen present in the system, which is broken down by delivering electrons that allow this oxidation of the ferric ion.

In case of copper minerals, for example, it can be indicated that the importance of the dissolved oxygen in the solution is represented by the following equations, where it is observed that the oxygen helps the sulfides to the oxidation of the sulfide ion and also the ferrous ion, thus helping the release of the valuable species of copper.

Equations representing this phenomenon:

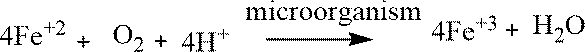

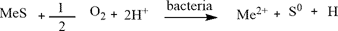

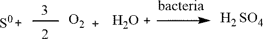

These equations can be extended to other minerals such as uranium, zinc, silver, gold, nickel, cobalt, among others, where oxygen is required for the development of their respective leaching kinetics.

The minerals that are processed with methods called “Bacterial Leaching”, have different species of bacteria, in accordance with what is established by Juan Manuel Sánchez in his study. It is established that these obtain their growth energy by oxidation of reduced sulfur compounds, thiosulfates and elemental sulfur, including that oxidizing ferrous to ferric ion and a wide range of metal sulfides to soluble sulfates.

In addition, it states that carbon sources are required, which can be satisfied by the fixing of CO₂, obtaining it from the atmosphere. Bacteria also have the ability to fix atmospheric N₂ and other inorganic forms of nitrogen, such as ammonium and nitrate.

The most used process corresponds to the leaching of minerals is carried out in leaching piles, which consist of large accumulations of ground mineral, where the leaching solution is added. This consists of an aqueous solution of an acid. The type of acid and its proportion depends on factors such as: mineral species, particle size, valuable metal content, etc. The sulfuric acid leaching process is the most used. The piles generally have a pyramidal shape of one or more levels, with approximate dimensions of 100 × 500 meters of base and 20 to 30 meters of height for each level.

The leaching solution accumulates in pools or tanks, from where it is pumped and sent to the upper level area of the piles. This is accomplished by a network comprising ducts of different diameter and a multitude of sprinklers or drips. In this way the leaching solution is distributed by gravity, towards the lower area of the pile, where the phenomenon of transfer of the valuable metal occurs, by the leaching process. The leaching solution is then collected by channels and ducts located at the base of each pile and transferred to the following solvent extraction and electrolysis processes.

To increase the efficiency of the leaching step, the piles have been incorporated at their base and other sectors of each level, one or more ductworks and pipes for the injection of forced air. These ductworks are independent of the leaching solution distribution network and are arranged so as to inject atmospheric air into the pile. This system used for a long time by the industry has a low efficiency in the transfer of oxygen present in the air to the pile, which generates enormous economic and productive losses for the mining industry and forces them to dispose of a greater amount of mineral in the piles to reach their production requirements, with a significant economic and environmental cost.

In this conventional procedure, the oxygen present in the air should be dissolved in the leaching solution as follows:

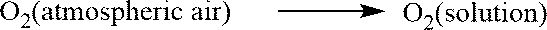

At the end of the lifetime of a pile, companies remove the leaching solution for reuse from the top of the distribution circuits. Then the leaching pile is dismantled and most of the aeration ducts in it are mistreated or destroyed and its subsequent reuse is not possible, becoming a dangerous waste.

Currently, this forced ventilation technique does not solve the problem of the low transfer from the mineral to the leaching solution, due to factors such as the following:
The equipment and facilities required for the injection of air into the leach piles are complex and expensive to operate, due to their installation, operation and maintenance.
The distribution of air inside the pile is not homogeneous, because the air injected represents only part of the oxygen required by the leaching solution and the other part escapes from the pile through the interstices of the mineral outwards.
The minerals to be leached usually have different compositions and physical and chemical characteristics such as particle size, permeability, oxidation state, which implies a non-uniform mineral mass, which makes it difficult to transfer and in addition to not being able to control the transfer of oxygen from the gas phase to the mineral.
The oxygen content at sea level in the air is 20.85%. These mining operations generally work at geographical heights above 2500 masl, which produces a decrease in atmospheric pressure, implying a decrease in the proportion of oxygen available in the atmosphere.

It is very important for the efficiency of leaching processes, control and management over the presence of dissolved oxygen in the solution, since this gas contributes to the oxidation of the valuable species. When the amount of oxygen available or dissolved is increased, the speeds of the leaching processes also increase, obtaining a greater amount of valuable metal. On the contrary, the lack of oxygen causes that not all the metal is managed to leach and ends up in the dumps at the end of its shelf life.

It is defined as dissolved oxygen (DO), as the amount of gaseous oxygen that is dissolved in the water. Free oxygen is central to the lives of fish, plants, algae and other organisms. This is achieved by diffusion of the surrounding air, aeration of water that has fallen over jumps or rapids and as a waste product of photosynthesis.

Among the factors that affect the levels of dissolved oxygen in mineral leaching is the temperature of the solution, atmospheric pressure and the geographical height. For water at sea level the value can range from 8 to 10 mg/l. This may also be expressed in terms of percent saturation so as to have a comparison tool. The percentage of saturation is the dissolved oxygen reading in mg/l divided by 100% of the dissolved oxygen value for water at the same temperature and air pressure

The presence or absence of oxygen allows to control the parameter called “Redox Potential”, which is expressed in [mV/ENH], which is a widely used technique in the leaching of sulphides, since it also controls the mineral reducers and the oxidation states of the iron in the leaching of oxides and thus defines the secondary compounds that they form.

According to the species and their fractions, an adequate combination of the gases such as: oxygen, carbon dioxide, nitrogen, nitrous oxide, air, etc. is required since they have an important role in the kinetic reactions that happen inside the pile.

In the solvent extraction process, the solution resulting from the leaching process is transferred to the so-called solvent extraction (SX) process, which corresponds to a concentration procedure to selectively extract, for example, the copper contained in this rich solution containing impurities, by ion exchange between the aqueous phase (rich solution) and the organic reagent. This reagent is capable of charging and subsequently discharging the copper at a later step of the process to a solution of high purity and concentration of copper and acid, forming an electrolyte suitable to be electrodeposited in the electrodeposition plants (EW). The minerals recovered by this technology are mainly copper, cobalt, nickel, platinum, zinc, among others.

Due to the characteristics and physical properties of the organic extractant, two important problems are generated in this process called “Organic debris” and “Aqueous debris” respectively, according to the predominant element at the time of mixing the two immiscible phases.

These debris generate significant losses in the quality of the final product and economic in the process, due to the contamination of the cathodes, for example, in the copper industry, it is estimated an average of the losses in an index of 2 kilos of organic phase per ton of copper cathodes produced. As a result of the above, some of these plants use a part of the process with cells named as sacrificial cells.

Because these cells are the closest to the entry of the electrolyte from solvent extraction, most of this contamination accumulates in them and in this way the problem inside the electro-obtaining plants is minimized. The metal obtained in these conditions has a lower quality chemical physics, due to said contamination it prevents the homogeneous deposition of the metal and contaminates the surface of the latter, at the time of its harvest. All metal obtained in these cells is discarded by quality controls, as rejection, performing its marketing low-value metal or simply as scrap metal.

In this process, there are different equipment, stages and procedures that allow to achieve the reduction of these debris:
a. The flotation columns that correspond to horizontal cylinders in which they inject the electrolyte, atmospheric air bubbles, of an average size (300 microns) and in a density, which allows capturing the present organic debris. The main characteristic of this equipment is that it allows to treat high solution flows.
b. The organic recovery pools where different equipment is installed that allow a mechanical recovery of the organic that is located due to its low density in the upper area of the solution.

Among these are rotating polypropylene belts, pneumatic pumps, meshes, etc., which allow capturing the organic available on the surface.

In the case of the elimination of the contamination of the extractant produced by the chloride ion from minerals such as atacamite (Cu₂Cl(OH)₃), the decontamination process comprises one or more stages of washing the organic with water, this implies enormous economic and environmental costs because these are the current processes, since it is a high cost element in the work and increasingly scarce.

Another procedure is the filtration of solutions, the filtration technique that consists of passing the electrolyte through filters filled with silica, garnet and anthracite, to contain these debris, which has been shown over time, to be ineffective. This is due to factors such as: The inputs are high cost, they do not allow to recover the extractant for use thereof, the extractant is discarded as a contaminant residue.

Currently there is the technology of transfer from a gas to a liquid by means of the generation of nanobubbles (NB) and microbubbles (UFB), which consists of the use of very small bubbles with very special characteristics, which has quickly consolidated in other industries such as the treatment of household, aquaculture, agricultural wastes, among others.

Nano- (NB) or ultrafine (UFB) bubbles are gas bubbles that are less than 1 micron (µm) in size. The closest comparison is a $10 coin compared to the Eiffel Tower and they can remain dissolved in the water for up to several months and are invisible to the naked eye, for which specialized equipment is required.

According to ISO 20480-1, nanobubbles or ultrafine bubbles are defined as those having a diameter of less than 1 micron and microbubbles whose size is less than 100 microns.

The size of the bubbles that are observed in everyday life, such as in soft drinks or Champagne, is more than 100 microns and gives floatability and then collapse on the surface.

Nanobubbles and microbubbles have important properties that differentiate them enormously from conventional size bubbles, among which are:
Long shelf-life stable in liquid: These may remain dissolved in the water for up to 6 months.
Negative charge (zeta potential). It disinfects water, because when the nanobubbles collapse they release enough energy to destroy the cell membranes of viruses and bacteria that are attracted to it.
Bubble floatability: The bubble’s ability to float is inversely proportional to its size, so one that has a size of 1 micron has an ascent rate of 0.544 µm/s. As shown in Table 1:

TABLE 1

| | |
|---|---|
| Diameter of a bubble | Increasing the speed of the bubble in the water |
| 100 µm | 5.440 µm/s |
| 10 µm | 54.4 µm/s = 19.6 cm/h |
| 1 µm | 0.544 µm/s = 2.0 cm/h |

Inside bubble pressure: By decreasing the size of the bubble, an increase in the pressure inside it is observed, reaching the impressive 29.7 atm for a size of 100 nm.

TABLE 2

| | |
|---|---|
| Bubble diameter | Pressure inside the bubble in the water |
| 1 mm | 1.003 atm |
| 100 µm | 1.03 atm |
| 10 µm | 1.29 atm |
| 1 µm | 3.9 atm |
| 500 nm | 5.8 atm |
| 300 nm | 9.7 atm |
| 200 nm | 14.6 atm |
| 100 nm | 29.7 atm |

High solubility of the gas in the liquid. Due to its high internal pressure of the nanobubbles, it makes its gas to liquid transfer rates extremely high compared to microbubbles. For example, one milliliter of nanobubble contains 1,000 times more surface area than one milliliter of a microbubble.

The aforementioned impressive properties of nanobubbles and microbubbles can be improved by the addition of a surfactant or surface-active agent. These are substances that modify the relationship between two surfaces, varying the surface tension between the phases in contact. When the surfactants are dissolved in water they are concentrated in interfaces such as: water-air, water-oil or mineral-leaching solution.

The function of these additives is to aid in the wetting, solubilization, and dispersion of the solids in an aqueous medium. Depending on the type of surfactant or surface-active used, foaming can be favored or prevented; they also give brightness and affect certain rheological properties of solutions.

The impact of a surfactant is measured with surface tension. This can be described as the amount of energy needed to increase the area per unit area. The main reason for this phenomenon is based on the fact that the forces that affect each molecule are different in the interior of the liquid and on the surface, so in the cavity of a liquid each molecule is subjected to forces of attraction that are annulled on average, thus allowing said molecule to acquire low energy. The behavior of the surface tension of a surface-active agent of natural origin called Quillay’s Saponin is attached.

TABLE 3

| Quillaja Saponin Surfactant (ppm) | Surface Tension (dyne/cm) |
|---|---|
| 0.0 | 73.5 |
| 1.1 | 67.3 |
| 2.6 | 58.8 |
| 7.5 | 48.2 |
| 16.0 | 45.0 |

This decrease in the surface tension of a liquid impacts a phenomenon called wetting, which is defined by the affinity between a liquid and a solid. The adhesion and cohesion forces between these phases determine the contact angle, such that, if the adhesion forces are much greater than the cohesion forces, then the liquid is said to wet the solid and the contact angle between the liquid and the solid surface is less than 90°, for the opposite case in which the adhesion forces are much greater than the cohesion forces it is said that the liquid does not wet the solid and the contact angle is greater than 90°. The presence of a surfactant in an interface generally produces a change in tension, varying the wettability of the liquid over the solid.

According to experiments conducted by Kennecott Copper Corporation in its patent, the addition of an effective amount of one or more surfactants to the aqueous phase of the lixiviants developed bubbles of the desired size range and a substantially reduced coalescence of bubbles. With a surfactant, the size of the bubbles is within the range of 0.1 to 0.5 mm (lixiviant at atmospheric pressure). Without a surfactant, two-phase lixiviants produced under identical conditions have a bubble size range of 1.0 to 1.5 mm, according to their experience.

For all the above reasons, it is clear that, in all the stages and processes mentioned, the presence of the gases that facilitate or even are part of the final result is of vital importance. These gases must be in the right quantity and proportion to achieve the maximum efficiency of the processes.

The present application promotes a novel composition that, by its application, significantly increases the efficiency of these processes, because it allows a greater control of the kinetics of each of them.

For the drafting of the present application, the prior art in the mining-metallurgical industry of the country and in the industry of electroplating and metal coatings was investigated, collecting existing information in the theoretical and practical field, different companies and workshops of melting, chromium plating, jewelry, hard chromium plating and galvanizing.

In the search for the prior art relating to the present application, the closest ones found are: National Application 201701589 describes a method for recovering copper or other metal.
https://patents.justia.com/patent/4360234
Describes a device for producing fine bubbles in a leaching solution larger than nanobubbles.
https://patents.google.com/patent/US5250273A/en
Describes a leaching procedure
https://patents.justia.com/patent/4664680
Describes a water oxygenation procedure
https://patents.justia.com/patent/4664680
Describes a device to obtain nanobubbles
http://www.freepatentsonline.com/y2017/0259219.html
Describes a nanobubble-generating device
Bibliography and Links of Interest
Metal finishing handbook edition 1972 page 272
Slime coating of kaolinite on chalcopyrite in saline water flotation, International Journal of Minerals, Metallurgy and Materials, Volume 25, Number 5, May 2018, Page 481.
https://www.redalyc.org/pdf/2230/223017807002.pdf
https://es.slideshare.net/KenNPooL/aglomeracin
https://ecometales.cl/operaciones-y-proyectos/lixiviacion-de-concentrados-de-cobre-plcc
https://www.terram.cl/2017/06/alta-presencia-de-arsenico-afecta-negocio-del-concentrado-de-cobre/
http://bibliotecadigital.ciren.cl/bitstream/handle/123456789/6825/CONAMA-HUM0863_v2.pdf?sequence=1&isAllowed=y
https://www.acniti.com/es/blog/las-personas-inteligentes-hablan-burbujas-innovacin-de-agua/
https://www.acniti.com/es/tecnolog%C3%ADa/que-son-burbujas/
https://www.acniti.com/es/tecnolog%C3%ADa/iso-burbujas-finas/
https://www.acniti.com/es/tags/ox%C3%ADgeno-disuelto/
http://eeer.org/journal/view.php?number=971
https://www.sciencedirect.com/science/article/pii/S0045653511006242#! http://www.ultrafb.cl/
file:///C:/Users/USUARIO/Downloads/Tesis_Efecto de_la_reaccion en_las_pilas de_biolixiv iacion..Image.Marked%20(1 ).pdf
file:///C:/Users/USUARIO/Downloads/Tecnicas_Lixiviaci%C3%B3n_en_Pilas_HIDROPROC ESS.2013%20Terral%20(1 ).pdf http://webdelprofesor.ula.ve/ingenieria/marquezronald/wp-content/uploads/fundamentos- teoricos.pdf

### DESCRIPTION OF THE INVENTION

The present application discloses an aqueous composition that is applied in strategic processes and of greater impact on the efficiency of hydrometallurgy and pyrometallurgy, detailed in the following list and flow diagram shown on sheet 5/5.
Mineral flotation
Leaching of high arsenic minerals
Leaching of melting metal powders
Electrorefining.
Leaching of Minerals in piles
Solvent extraction
Concentrate leaching

The composition of the present application comprises: One or more surfactants and one or more adjuvant gases in the hydrometallurgical and pyrometallurgical processes in which it is applied, which are added thereto in the state of nanobubbles and microbubbles. In addition, it understands that both the gases used and the nanobubbles and the microbubbles thereof, are in a variable proportion depending on the physicochemical requirements of each of the stages of the process where it is applied.

More specifically, the present invention discloses an aqueous composition that increases the efficiency in the hydro metallurgical and pyrometallurgical processes of metal extraction such as: copper, zinc, gold, uranium, silver, nickel comprising: water, at least one surface-active agent and one or more gases that are adjuvants of these processes, in the nano- and microbubble state.

In the present invention the water may be drinking water, industrial water, sea water, a leaching solution or a mixture thereof.

In the present invention preferably the surface-active agent is saponin and is used in a range between 0.1 ppm and 30 ppm.

In another embodiment of the present invention the surface-active agent may be one of the groups: hydrocarbon compounds, fluorocarbonate or mixtures thereof.

In the present invention the size of the nanobubbles is in the range of 1 nm to 1 µm.

In the present invention preferably the size of the nanobubbles is 100 nm

In the present invention the size of the microbubbles is in the range of 1 µm to 100 µm.

Further, the present invention discloses a process for applying the above disclosed aqueous composition:

The process comprises the following steps:
a) connecting a source supplying the gases to be injected with the nano- and/or microbubble generator;
b) selecting the proportion of gases to be injected;
c) activating the nanobubble and microbubble producing source;
d) connecting the nanobubble and microbubble generating source to a conduit that conveys the leaching solution to the leaching pile of a solution tank;
e) adding the nanobubble and microbubble composition to the tank containing the water or to the tank containing the leaching solution.

Furthermore, the present invention discloses the use of the above-disclosed aqueous composition in processes such as: mineral flotation, concentrate leaching, clay mineral flotation, arsenic mineral leaching, metal powder leaching, agitated mineral leaching, electrorefining, agglomerating, pile leaching and solvent extraction.

The nanobubbles and microbubbles, of the proposed composition, make it possible to significantly increase the physicochemical properties of these gases such as: flotation speed, oxidizing power, reducing power, contact area provided and coalescence speed.

The gases that can be considered adjuvants of the hydrometallurgy and pyrometallurgy processes are: pure oxygen, ozone, carbon dioxide, nitrogen, nitrous oxide, air, helium, argon or any other gas or mixture thereof, which, due to their physical or chemical properties, favor the kinetics of said processes.

In the present invention more specifically the adjuvant gases are selected from: oxygen, ozone, air, nitrogen dioxide, argon, nitrogen, helium, carbon dioxide or mixtures thereof.

In the mineral flotation process, the proposed composition allows, through its application, the recovery of the particles of valuable mineral of fine and ultrafine size, which currently is not recovered by the bubbles of conventional size, thus avoiding the loss of this valuable fraction and also preventing it from being discarded in tailings reservoirs, with the consequent increase in the environmental pollution that this implies.

By incorporating the composition of nanobubbles and microbubbles, they provide greater contact area or surface for the capture of valuable species and due to their size, they are distributed throughout in volume of the flotation solution that is between the conventional bubbles. In this way they capture on their surface the particles of fine and ultrafine mineral that has not been recovered by conventional bubbles.

Mineral-laden nanobubbles and microbubbles coalesce with conventional sized bubbles and rise up the water column to the surface where it is collected.

To favor the flotation of the different types of minerals and cover their different physical properties such as specific weight or presence of steriles and dimensions of the flotation equipment, the composition comprises that the gases used to obtain them are: oxygen, air, argon, helium, a mixture of them or another gas that is adjunctive to the process.

In flotation of minerals with high content of fine clays, the application of the proposed composition allows the capture of the particles of these elements that present a fine and ultrafine particle size.

Nanobubbles and microbubbles capture these particles and then coalesce with each other first and then with conventional bubbles.

In this way the fine clay particles float towards the surface where they are collected. For this process the composition comprises that the adjuvant gases of the flotation are: air, argon, helium or other gas, or mixture thereof.

For the agitated leaching process of high arsenic sulfur minerals, the composition comprises that the gases of the composition that the gases used for obtaining the nanobubbles and microbubbles is oxygen, ozone, air or mixture thereof. Thus, arsenic is oxidized in an efficient and controlled manner, avoiding the use of oxidizing agents such as hydrogen peroxide.

In the process of leaching metal concentrates, the application of the composition in the water with which the pulp is formed allows, in the presence of sulfuric acid, to precipitate arsenic and oxidize metal sulfides forming sulfates. The enormous amount of contact area provided by the nanobubbles and microbubbles of the proposed composition, allow the control of the kinetics of the reaction, significantly increasing the efficiency of the process, and decreasing the amount of energy required. For this process, the composition comprises that the adjuvant gases for leaching concentrates are: air, ozone, oxygen, or a mixture thereof.

In the process of leaching metal powders from melting, the composition comprises that the gases used for obtaining the nanobubbles and microbubbles is oxygen, ozone, air or a mixture thereof. The nanobubbles and microbubbles of this composition efficiently provide the oxygen necessary for the efficient leaching of metallic melting powders, avoiding the use of dangerous and difficult-to-manage reagents such as hydrogen peroxide.

For the electrorefining process, the composition comprises that the gases used to obtain the nanobubbles and microbubbles are: oxygen, ozone, air or mixture thereof. The composition is applied to the ducts carrying the electrolyte to the electrorefining cells, where the nanobubbles and microbubbles increase the dissolved oxygen available in the contact zone between the anodes and the electrolyte. This eliminates the passivation of the anode by avoiding the formation of cuprous ions, generating an increase in the efficiency of the process.

In the mineral agglomeration process prior to leaching, the application of the proposed composition, in the water or leaching solution used to form the pulp, allows ensuring the presence of oxygen throughout the interior of the glomer, in its microcracks and interstices. Thus, the chemical reaction of the leaching is favored and the kinetics of the leaching piles are increased, thereby reducing the time of treatment of the mineral in them. For this agglomeration process, the composition comprises that the gases used to obtain the nanobubbles and microbubbles are: air, oxygen, ozone, a mixture thereof, or another gas that is adjuvant to the subsequent process that is leaching.

For the process of leaching minerals into piles, the composition comprises that the gases used to obtain the nanobubbles and microbubbles are: oxygen, ozone, air or mixture thereof. The proposed composition is added to the leaching solution before it is incorporated into the leaching piles, whereby the same flow of said solution is transformed into the medium of distribution of the adjuvant gases to all sectors of the pile. This is added to the duct or pipe that conveys the leaching solution to the leachate pile or to the pools or tanks where the leaching solution is accumulated before being sent to the pile.

The application of the proposed composition guarantees a high efficiency and control of the leaching of oxidized minerals, in addition to avoiding the use of forced aeration networks of the piles and the environmental pollution produced by the discarding of these ducts in the dumps.

In the solvent extraction process or SX, the proposed composition is applied for the removal of aqueous debris and for the removal of organic debris.

For the removal of organic debris in pools, tanks or wells for intermediate and final solutions, the proposed composition is applied in the flotation columns and/or in the pools. The composition is applied to the ducts that provide the water or directly to the columns or pools. For application in these two processes, the proposed composition comprises that the gases used for obtaining the nanobubbles and microbubbles are: air, nitrogen, argon or helium in pure form or mixture thereof.

For aqueous debris, the proposed composition allows them to coalesce with water microdroplets or aqueous debris contaminated with chloride ion, thus facilitating their capture and coalescence. In this way, the application of the proposed composition efficiently allows the removal of contamination with the chloride ion, contained in the water microdroplets present in the extractant, significantly reducing the consumption of water and avoiding the use of filtering systems.

After the solvent extraction process the proposed composition can also be applied to the enriched electrolyte for removal of the organic debris present therein. The nanobubbles and microbubbles of the composition coalesce with the microdroplets of organic extractant, increasing their floatability and therefore facilitating their separation and recovery on the surface of the tanks or pools, also allowing the recovery of this debris, avoiding loss of this valuable element

For application in the organic debris recovery step, the composition comprises that the gases used for obtaining the nanobubbles and microbubbles is oxygen, ozone, air, argon, helium or a mixture thereof. The composition is applied to electrolyte accumulating pools or tanks that are arranged between the solvent extraction and electro-obtaining processes.

### Composition and Application Examples

Example of the proposed composition applied in the mineral leaching step.

A laboratory test was carried out on leaching columns, with 5 kilos of mixed mineral from a deposit in the second region of Chile, which had a composition of 0.53% of total copper and 0.15% of soluble copper and also 20 liters of electrolyte.

For them, a preparation of the mineral was carried out at P100 = 1½ (in) and then proceeded to the homogeneous separation of each of the columns. Subsequently, the acid curing process (10 kg/ton) was generated, where the mineral was rolled until the correct curing process of the sample was achieved. This was allowed to stand for a period of 24 hours.

Subsequently, each of the columns of 1 meter in height was loaded with 1 kilo of mineral, carefully and homogeneously, so as not to damage the glomers and allowed to rest in the column.

After 3 days, the irrigation step was started with recirculation, with electrolyte that is composed of water (96%), copper sulfate (1%), sulfuric acid (3%) and quillaja saponin (5 ppm), at a rate of 8 (It/hr/m²)

In the electrolyte accumulation tank, which feeds the irrigation system pump, the nanobubble generation equipment, fed with pure oxygen, was connected at 20 PSI and 0.8 liter/minute flow.

After 3 hours, the nano bubbles of oxygen dissolved in the electrolyte, allowed the value of oxygen dissolved in the electrolyte to rise from 10 ppm to between 25 and 27 ppm, also remained in that range throughout the test.

The efficacy of the proposed composition was noted when performing the measurements of dissolved copper and sulfuric acid. The copper recovery was determined to be 63.2% and at the current prior art this value is close to 45.6%.

These tests were carried out in duplicate, in a total of 4 columns

For the preparation of the proposed composition, the following equipment is required:
A supplier source of the gas(s) to be used that is composed of one or more generating equipment of the gas(s) to be used or tank of any supplier of these industrial gases.
A storage tank consisting of a tank of suitable volume containing the water or leaching solution to which it or the nano- or microbubbles of gases will be added.
A nanobubble and/or microbubble generating equipment comprising one or more nanobubble and microbubble generating equipment purchased from a supplier, according to the requirements and needs of use for each process to which the composition is applied.
A storage tank for the prepared composition comprising a pool of suitable volume containing the composition and connected with the duct carrying the prepared composition to the process where it is applied.

For the control of the preparation of the composition, the same variables and measurement equipment of the solutions used in the processes are used, such as, dissolved oxygen (ppm of 02), Percentage of saturation (%), bubble size (nm), and bubble frequency (%) of the type of bubbles (nano or micro), type and composition of dissolved gases, etc.

Both the accumulation tanks, as well as the nanobubble and microbubble generating equipment are properly connected by a pumping system, ducts and suitable valves, so that the prepared composition is added to each process.

The procedure for preparation and application of the composition comprises the following steps:
a) Connect the sources supplying the gas or gases to be injected with the nanobubble generator.
b) Selecting the proportion of gases to be injected
c) Activating the nanobubble and microbubble production source.
d) Connecting the nanobubble generating source to the composition storage tank.
e) Measuring the parameters of size, proportion and composition of gases.
f) Adding nanobubbles to meet the requirements of the process to which the composition is to be applied.
g) Adding nanobubble and microbubble composition to the process to which it will be applied.

### Example of the Composition and Application Thereof

To obtain 1,000 liters of the proposed composition to be applied to the process of leaching minerals into piles, the following procedure must be followed.
a) Connecting the nanobubble generating equipment to an oxygen cylinder (b)
b) Connecting the nanobubble generating source to the accumulation tank (b)
c) Activating the nanobubble generating equipment
d) Measuring dissolved oxygen
e) Adding oxygen nanobubbles until a concentration of 16 ppm of dissolved oxygen is obtained, and
f) Adding the composition to the heap leaching process.

Example of application of the proposed composition in increasing dissolved oxygen.

The proposed composition was applied to two different aqueous media to visualize the beneficial effect on the content of oxygen dissolved in type IV water (Maximum 5 µS/cm) and copper refining electrolyte with 1.2 g/l of copper and 15.4 g/l of sulfuric acid, also comparing with the effect of conventional compressed air and the use of oxygen, under different conditions of geographical height, sea level and 2,326 meters above sea level, in addition to the addition of surfactant agent.

These tests were performed with IDEC FZ1N-04M nanobubble generating equipment and recorded with a portable dissolved oxygen monitor YSI ProODO model and with a preferred size less than 100 nm of nanobubble diameter.

The results are shown in Table 4.

TABLE 4

| Test | Barometric Pressure (hPa) | Geographic Height (msnm) | Flow rate Liq (l/min) | Liq temp. (°C) | Water Type | Gas flow rate(l/min) | Gas Type | Surfactant Quillay (PPm) | Surface Tension (dyne/cm) | Amount of turns to the tank | Time (sec) | Dissolved Oxygen (ppm O₂) |
|---|---|---|---|---|---|---|---|---|---|---|---|---|
| 1 | 1012.9 | 23 | 7.5 | 20.1 | Type IV | 8.35 | compressed air | | | 0 | 8 | 10.1 |
| 2 | 1012.9 | 23 | 7.5 | 20.3 | Type IV | 0.35 | compressed air | | | 1 | 180 | 10.8 |
| 3 | 1012.9 | 23 | 7.5 | 20.3 | Type IV | 8.35 | compressed air | | | 2 | 360 | 11.1 |
| 4 | 1012.9 | 23 | 7.5 | 202 | Type IV | 0.35 | compressed air | | | 3 | 540 | 11.5 |
| 5 | 1012.9 | 23 | 7.5 | 20.1 | Type IV | 8.35 | oxygen | | | 0 | 8 | 10.2 |
| 6 | 1012.9 | 23 | 7.5 | 20.1 | Type IV | 0.35 | oxygen | | | 1 | 180 | 16.2 |
| 7 | 1012.9 | 23 | 7.5 | 20.3 | Type IV | 0.35 | oxygen | | | 2 | 360 | 23.4 |
| 8 | 1012.9 | 23 | 7.5 | 202 | Type IV | 0.35 | oxygen | | | 3 | 540 | 30.5 |
| 9 | 1012.9 | 23 | 7.5 | 20.5 | Copper refining | 0.35 | oxygen | | | 0 | 0 | 6.0 |
| 10 | 1012.9 | 23 | 7.5 | 20.7 | Copper refining | 0.35 | oxygen | | | 1 | 180 | 9.0 |
| 11 | 1012.9 | 23 | 7.5 | 20.6 | Copper refining | 0.35 | oxygen | | | 2 | 360 | 12.6 |
| 12 | 1012.9 | 23 | 7.5 | 20.6 | Copper refining | 0.35 | oxygen | | | 3 | 540 | 16.2 |
| 13 | 759.9 | 2326 | 7.5 | 20.2 | Type IV | 0.35 | compressed air | | | 0 | 0 | 7.2 |
| 14 | 759.9 | 2326 | 7.5 | 20.3 | Type IV | 0.35 | compressed air | | | 1 | 180 | 7.6 |
| 15 | 759.9 | 2326 | 7.5 | 20.3 | Type IV | 0.35 | compressed air | | | 2 | 360 | 8.2 |
| 16 | 759.9 | 2326 | 7.5 | 20.1 | Type IV | 0.35 | compressed air | | | 3 | 540 | 8.3 |
| 17 | 759.9 | 2326 | 7.5 | 20.2 | Type IV | 0.35 | oxygen | | | 0 | 8 | 7.2 |
| 18 | 759.9 | 2326 | 7.5 | 20.1 | Type IV | 0.35 | oxygen | | | 1 | 180 | 12.9 |
| 19 | 759.9 | 2326 | 7.5 | 20.5 | Type IV | 0.35 | oxygen | | | 2 | 360 | 17.7 |
| 20 | 759.9 | 2326 | 7.5 | 202 | Type IV | 0.35 | oxygen | | | 3 | 540 | 24.3 |
| 21 | 759.9 | 2326 | 7.5 | 20.1 | Copper refining | 0.35 | oxygen | | | 0 | 0 | 3.2 |
| 22 | 759.9 | 2326 | 7.5 | 20.3 | Copper refining | 0.35 | oxygen | | | 1 | 180 | 4.8 |
| 23 | 759.9 | 2326 | 7.5 | 20.3 | Copper refining | 0.35 | oxygen | | | 2 | 360 | 67 |
| 24 | 759.9 | 2326 | 7.5 | 202 | Copper refining | 0.35 | oxygen | | | 3 | 540 | 8.6 |
| 25 | 759.9 | 2326 | 7.5 | 21.1 | Copper refining | 0.35 | oxygen | | | 0 | 0 | 3.2 |
| 26 | 759.9 | 2326 | 7.5 | 21 | Copper refining | 0.35 | oxygen | 11 | 46.82 | 1 | 180 | 5.8 |
| 27 | 759.9 | 2326 | 7.5 | 21.2 | Copper refining | 0.35 | oxygen | 11 | 46.82 | 2 | 360 | 10.4 |
| 28 | 759.9 | 2326 | 7.5 | 21.1 | Copper refining | 0.35 | oxygen | 11 | 46.82 | 3 | 540 | 16.6 |

The results show that the amount of dissolved oxygen present in the water depends on factors such as the quality of the type of water, geographical height and content of salts present, which agrees with what is collected in the prior art.

In reviewing in detail, it is also observed that, when performing such tests at sea level, the amount of oxygen transferred by applying the composition allows reaching a value of 30 ppm of O₂, after 3 recirculation processes. In comparison, performing these tests only with conventional compressed air achieves only 11.5 ppm of O₂.

The foregoing indicates that the amount of oxygen present in the atmospheric air does not strongly impact the dissolved oxygen in the sample. By carrying out a similar experiment in a copper refining solution, a value of 16.2 ppm of O₂ is reached at sea level.

Since the mining operations are over 2,000 meters high in Chile, the importance of this variable must be analyzed, so it repeats these tests with the same conditions, reaching only 8.3 ppm of O₂ for the case of compressed air, with oxygen a value of 24.3 ppm of O₂. Then this experiment is performed with copper refining, a value of 8.6 ppm of O₂ is reached. Finally, the test is carried out with a surfactant, where a concentration of 11 ppm of surfactant Quillaja Saponin is added, observing that a value of 16.6 ppm of O₂ is reached.

The foregoing makes it possible to affirm that regardless of the characteristics of the available aqueous solutions, by applying the proposed aqueous composition of nano and microbubbles, it is possible to significantly increase the degree of dissolution of a gas such as dissolved oxygen. By significantly increasing the amount of the gas or gases dissolved in the solutions, the beneficial impact of them is increased, in the processes to which they are applied.

### Example of Application of the Composition in the Copper Electrorefining Process

The following table 5 shows the result of the tests carried out to measure the effect of the proposed composition on the anodic efficiency in copper electro refining process as a function of the dissolved oxygen in the electrolyte.

Three Hull cell assays were carried out, with copper anode, copper foil cathode, electrolyte with 40 grams per liter of dissolved copper and 180 grams per liter of sulfuric acid. For air agitation the air injection agitation system of the Hull cell kit was used and for the electrolyte recirculation a centrifugal pump was used which provided a flow of 1 cubic meter per hour. The anodic efficiency is reflected by the behavior of the current intensity as a function of the working time, for the same voltage. The drop in current intensity is a reflection of the passivation of the anode.

In each test a voltage of 2.0 volts and a current intensity of 2.0 Amps were applied, which are the standard values for this process and these data were recorded every 10 minutes.

In test number three, the proposed composition was applied to the electrolyte flow, with nanobubbles of 81 nm size, until a saturation of 175% of oxygen was obtained.

Test 1: Represents anode efficiency behavior at the current prior art in electro refining cells

TABLE 5

| Voltage (V) | Current (Amp) | Temperature °C | Time (min) |
|---|---|---|---|
| 2 | 2 | 55 | 10 |
| 2 | 1.8 | 55 | 20 |
| 2 | 1.7 | 55 | 30 |
| 2 | 1.7 | 55 | 40 |
| 2.1 | 1.6 | 55 | 50 |
| 2.1 | 1.4 | 55 | 60 |
| 2.1 | 1.2 | 55 | 70 |

Test 2: With agitation, by bubble air injection

TABLE 6

| Voltage (V) | Current (Amp) | Temperature °C | Time (min) |
|---|---|---|---|
| 2 | 2 | 55 | 10 |
| 2 | 2.1 | 54 | 20 |
| 2 | 2.1 | 54 | 30 |
| 2 | 2 | 53 | 40 |
| 2 | 2 | 53 | 50 |
| 2 | 1.8 | 50 | 60 |
| 2 | 1.8 | 50 | 70 |

Test 3: With O₂ Saturation of oxygen (175%), by oxygen nanobubbles of composition.

TABLE 7

| Voltage (V) | Current (Amp) | Temperature °C | Time (min) |
|---|---|---|---|
| 2 | 2.1 | 55 | 10 |
| 2 | 2.1 | 55 | 20 |
| 2 | 2.2 | 55 | 30 |
| 2 | 2.2 | 55 | 40 |
| 2 | 2.1 | 55 | 50 |
| 2 | 2.2 | 55 | 60 |
| 2 | 2.2 | 55 | 70 |

The application of the composition in test number three made it possible to avoid anodic passivation and maintain a high anodic efficiency, without influencing the temperature of the electrolyte or contaminating it.

### Description of the Sheets

Sheet 1 represents a schematic of the connection of the gas supplier source and the nano- and microbubble generating source where:
a) Is the gas supplier source
b) It is the nanobubble and microbubble generating source
c) It is the water accumulation tank or leaching solution.
d) It is the connection system between the nanobubble and microbubble generating source.
e) It is the tank with the prepared composition

The hatched area represents the presence of nanobubbles and microbubbles Sheet 2 represents a schematic of the hydro-metallurgical process of metal extraction by means of the mineral leaching process where:
f) Is the leaching pile
g) It is the outlet pool of the electrolyte that each pile has
h) It is the pool of electrolyte accumulation coming from the piles
i) It is the solvent extraction process
j) It is the electro-obtaining plant
k) It is the pool of electrolyte accumulation that passes to the pile
I) It is the irrigation duct between the settling pool and the leaching pile
m) It is the forced aeration system of the pile

Sheet 3 depicts a schematic of the connection of the nanobubble and microbubble generating source to the leaching solution accumulation pool where:
n) It is the pool
The hatched zone represents the leaching solution
Sheet 4 depicts a schematic of a mineral flotation tank where:
ñ) It is the zone of the volume of the solution where the hatched zone represents the sectors in which conventional size bubbles are not present.

1. An aqueous composition that increases the efficiency in the hydro-metallurgical and pyrometallurgical processes of metal extraction comprising: water, at least one surface-active agent and one or more gases that are adjuvants of these processes, in the nano and microbubble state.

2. The composition according to claim 1, wherein the water can be drinking water, industrial water, sea water, a leaching solution or a mixture of the above.

3. The composition according to claim 1, wherein the surface-active agent is saponin.

4. The composition according to claim 3, wherein the concentration of the surface-active agent saponin comprises a range of between 0.1 ppm and 30 ppm.

5. The composition according to claim 1, wherein the surface-active agent can be one of the groups: hydrocarbonates, fluorocarbonate or mixtures thereof.

6. The composition according to claim 1, wherein said adjuvant gases are selected from the group consisting of: oxygen, ozone, air, nitrogen dioxide, argon, nitrogen, helium, carbon dioxide and mixtures thereof.

7. The composition according to claim 1, wherein the size of the nanobubbles is 100 nm.

8. The composition according to claim 1, wherein the size of the nanobubbles comprises a range of between 1 nm and 1 µm.

9. The composition according to claim 1, wherein the size of the microbubbles comprises a range of between 1 µm and 100 µm.

10. A process for applying the aqueous composition according to claim 1, wherein the process comprises the following steps:
a) connecting a source supplying the gases to be injected with the nano- and/or microbubble generator;
b) selecting the proportion of gases to be injected;
c) activating the nanobubble and microbubble producing source;
d) connecting the nanobubble and microbubble generating source to a conduit that conveys the leaching solution to the leaching pile of a solution tank;
e) adding the nanobubble and microbubble composition to the tank containing the water or to the tank containing the leaching solution.

11. The aqueous composition according to claim 1, wherein the composition is applied to the processes of: mineral flotation, leaching of concentrates, flotation of clay minerals, leaching of arsenic minerals, leaching of metal powders, agitated leaching of minerals, electrorefining, agglomeration, leaching in piles and solvent extraction.

12. The composition according to claim 1, wherein the metal is copper, zinc, gold, uranium, silver or nickel.
